(19) United States
(12) Patent Application Publication
(10) Pub. No.: US 2009/0268890 A1
(43) Pub. Date: Oct. 29, 2009

(54) TARGETING ADS BY TRACKING CALLS

(75) Inventor: Shekhar GUPTA, Overland Park, KS (US)

Correspondence Address: SONNENSCHEIN NATH & ROSENTHAL LLP, P.O. BOX 061080, WACKER DRIVE STATION, WILLIS TOWER, CHICAGO, IL, 60606-1080, US

(73) Assignee: EMBARQ HOLDINGS COMPANY, LLC

(21) Appl. No.: 12/108,029

(22) Filed: Apr. 23, 2008

(51) Int. Cl. H04M 15/00

(52) U.S. Cl. 379/112.06

(57) ABSTRACT

By providing a method for acquiring consumer data without user interaction, such as analyzing CDRs to identify consumers of businesses, for example, advertisers may more accurately target advertisements to users that are more likely to find the advertisements useful or relevant. CDRs may be utilized to identify specific callers or households who have called a particular or type of business, a concentration above a certain interest level who call certain businesses, or any other information indicative of interest in a topic, candidate, business, or similar entity that would benefit from advertising.

One embodiment includes a system and method for providing targeted advertisements. In this embodiment, a processor may be configured to capture call record data of customers of telecommunications services. The processor may further be configured to process the call record data to determine categories of interest of the customers. The processor may also be configured to generate information from the processed call record data, where the processed call record data associated with the customers may be included in the information if the call record data satisfies at least one criteria. The processor may also be configured to avail the information to advertisers for use in advertising.

### BACKGROUND OF THE INVENTION

Telecommunications service providers generate records of their users' calls in order to provide accurate bills to users. A call detail record (CDR) is stored in call data storage by telecommunications service providers and may be accessed by the telecommunications service providers as necessary. Traditionally, the CDRs are used for billing and other record keeping purposes. Some common fields in CDRs include the calling telephone number, receiving telephone number, date and time of call, and the duration of the call. More advanced CDRs may include a unique record identifier, telephone exchange identifiers, exchange route information, fault error messages, and several other data items that might be relevant to the call.

In the advertising world, statistics and other data pertaining to consumers are considered highly valuable assets. There are many different sources for information about consumers, such as telephone books, census reports, consumer surveys, and credit reports to name a few. New sources for relevant information are routinely sought after and prized by advertisers as well as political candidates or any other group where knowing more about their customers or constituents would be beneficial.

One disadvantage of some existing data sources used for providing targeted advertisements is that they are derived from methods requiring active participation by a consumer. Surveys and polls may be useful in determining consumer preferences, but a consumer likely has to take time out of his or her schedule to respond or to provide information, whish is a less than desirable activity for most consumers. Another disadvantage of existing data sources involves outdated data. The outdated data is then used to compile mailing lists or user profiles which will contain inaccuracies. A more passive method for deriving useful and accurate consumer data would be beneficial for deriving targeted advertisements.

### BRIEF SUMMARY OF THE INVENTION

By providing a method for acquiring consumer data without user interaction, such as analyzing CDRs to identify consumers of businesses, for example, advertisers may more accurately target advertisements to users that are more likely to find the advertisements useful or relevant. CDRs may be utilized to identify specific callers or households who have called a particular or type of business, a concentration above a certain interest level who call certain businesses, or any other information indicative of interest in a topic, candidate, business, or similar entity that would benefit from advertising.

One embodiment includes a system and method for providing targeted advertisements. In this embodiment, a processor may be configured to capture call record data of customers of telecommunications services. The processor may further be configured to process the call record data to determine categories of interest of the customers. The processor may also be configured to generate information from the processed call record data, where the processed call record data associated with the customers may be included in the information if the call record data satisfies at least one criteria. The processor may also be configured to avail the information to advertisers for use in advertising.

### BRIEF DESCRIPTION OF THE DRAWINGS

Illustrative embodiments of the present invention are described in detail below with reference to the attached drawing figures, which are incorporated by reference herein and wherein:

FIG. 1 is an illustration of an exemplary environment for collecting CDR data to provide targeted advertisements to customers;

FIG. 2 is an illustration of exemplary network equipment of a service provider configured to collect CDR information to provide targeted advertisements to customers;

FIG. 3 is a block diagram of exemplary components of a server configured to facilitate targeted advertisement selection;

FIG. 4 is a block diagram of exemplary modules for collecting CDR data to provide targeted advertisements to customers; and

FIG. 5 is a flow chart of an exemplary process for CDR data and providing targeted advertisements to customers in accordance with the principles of the present invention.

### DETAILED DESCRIPTION OF THE INVENTION

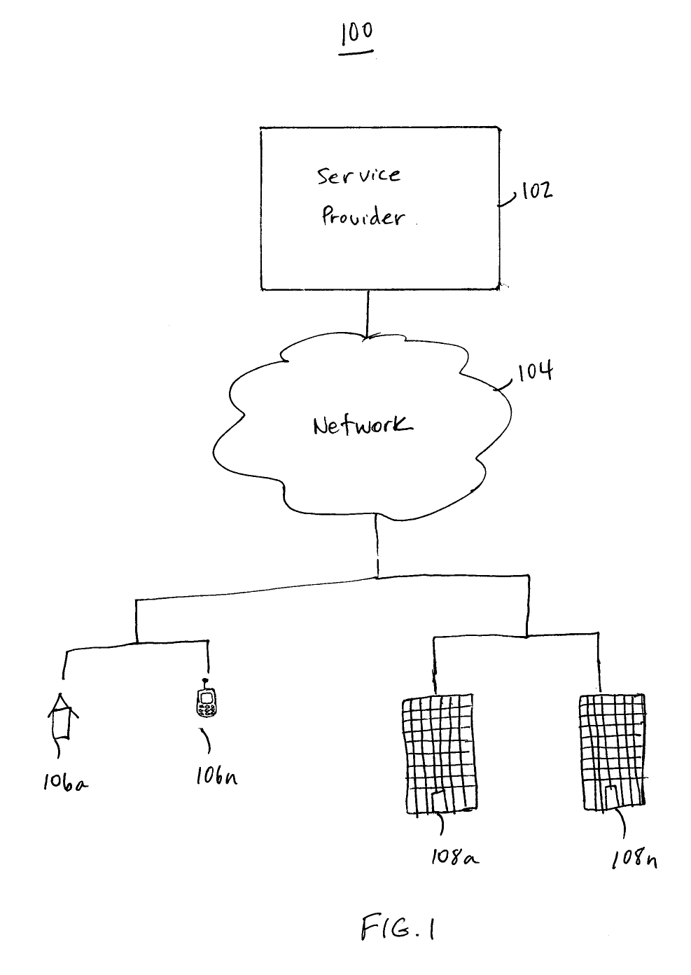

FIG. 1 is an illustration of an exemplary environment 100 for collecting CDR data to provide targeted advertisements to customers. In this embodiment, a service provider 102 communicates over a network 104 to customers, such as consumer customers 106a-106n (collectively 106) and business customers 108a-108n (collectively 108). The service provider 102 may be a telecommunications company, cable company, Internet service provider, or any other provider capable of providing call communications services. The network 104 may be a traditional public service telephone network (PSTN), a cellular network, such as CDMA or GSM, the Internet, or any other network capable of carrying call traffic. The consumer customers 106 may be customers that make calls primarily for personal use from a home or mobile telephone. Business customers 108 may be customers that make calls from businesses. It should be understood the principles of the present invention may be equipment independent so long as CDR data is available for a call.

An exemplary CDR may include caller name, caller telephone number, caller location, called party name, called party address, time of call, date of call, and any other call information as understood in the art. In the situation where the service provider 102 is the service provider for the caller, but not for the called party, information related to the called party, such as the called party name and address, may not be included. Further information regarding the production of the missing information will be explained below in greater detail. The CDRs may be collected at the service provider 102 and stored in a local data repository (not shown) or remotely on network storage. The CDRs may be replicated, in any method commonly known the art, as the CDRs are generated for additional protection in the event of storage device failure. An exemplary CDR is shown below in Table 1.

TABLE 1

| | Caller | | Called | Called | | | | Caller |
|---|---|---|---|---|---|---|---|---|
| | telephone | Caller | party | party | Date of | Time of | Length | account |
| Caller name | number | address | name | address | call | call | of call | ID |
| Bob Smith | 5552526594 | 12 Main. St., | Pizza | 56 Main St., | Jan. 11, 2008 | 13:04:05 | 00:05:02 | 1254896 |
| | | Dallas, TX | Shack | Dallas, TX | | | | |
| | | 75201 | | 75201 | | | | |
| . . . | . . . | . . . | . . . | . . . | . . . | . . . | . . . | . . . |
| . . . | . . . | . . . | . . . | . . . | . . . | . . . | . . . | . . . |

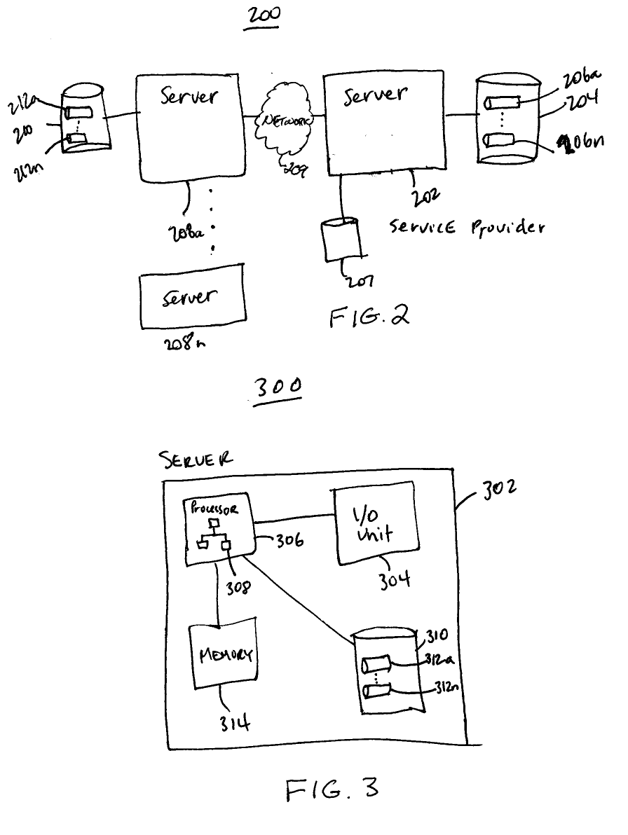

FIG. 2 is an illustration of an exemplary service provider 200, such as the service provider 102 in FIG. 1, which is capable of collecting CDR data to provide targeted advertisements. The service provider 200 may utilize a server 202 in communication with a data storage unit 204. The data storage unit 204 may include data repositories 206a-206n (collectively 206). The data storage unit 204 may be a hard drive or series of hard drives, memory, such as RAM or flash memory, or any other storage device capable of operating in the data storage unit 204. Data repositories 206 may be a file or group of files, one or more databases, or any other structure that may be used for data organization. The data repositories may be configured to store data available for the service provider to compare CDR data to generate information of call parties, such as call party demographics. CDR data may be stored in a CDR repository 207 or in any other repository (such as data storage unit 204) that is capable of storing call detail records. In one embodiment, one or more secondary servers 208a-208n (collectively 208) may also be in communication with the local server 202 via a network 209, such as the Internet or telecommunications network. The network 209 may be a telecommunications network, Internet, or any other network. The secondary servers 208 may be located at the same site as the service provider 200, or the secondary servers 208 may be remotely located from the service provider 200. Additionally, the secondary servers 208 may be in communication with the server 202 over a network. The secondary servers 208 may be operated by another service provider or business that has access to demographic or other user identifying data that, when used alone or in combination with the data stored in the data storage unit 204 of the server 202, becomes relevant or beneficial to the service provider 200 to collect CDR data.

Some examples of customer data records and publicly available data records may include a directory of telephone numbers, such as electronic yellow pages, census database, customer database or any other collection of data with business, demographic, statistical, or any other information that can provide a caller or called party information. The demographic or other user identifying data may be collected based on CDRs to identify callers to a particular called party (e.g., a particular business), callers to a type of called party (e.g., pizza restaurants), or particular called parties from a caller or types of called parties from a caller (e.g., households with income over $100,000).

Similar to the data storage unit 204, an additional storage unit 210 may be connected to the secondary servers 208. The additional data storage units 210 may include data repositories 212a-212n (collectively 212). The data repositories 212 may be a file or group of files, a database or multiple databases or any other structure used for data organization. The data repositories 212 may be configured to store CDR data or other information associated with customers of one or more communications service providers.

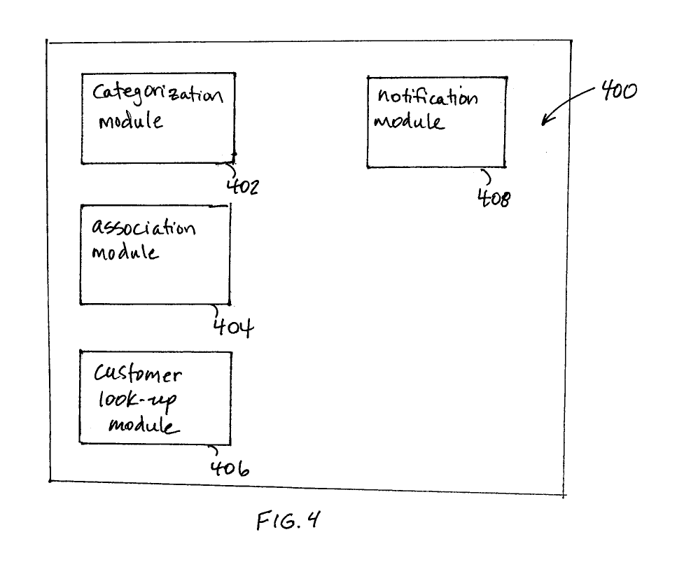

FIG. 3 is a block diagram of exemplary components 300 of a server 302 configured to collect CDR data and provide targeted advertisements. The server 302 may be located anywhere on a network (e.g., telecommunications or the Internet) that is capable of communicating data to a user. The server 302 may include an input/output (I/O) unit 304 for receiving commands and transmitting content. Some of the commands may include commands used for requesting CDRs to be made available for processing (e.g., sort or filter CDRs), importing external data (e.g., consumer lookup and retrieval of additional data from external or additional data sources), processing CDRs (e.g., filtering and sorting data from CDRs with that of the data retrieved from external data sources), and exporting processed information (e.g., commands for creating a mailing list), to name a few. Some examples of content that may be transmitted may be sorted and unsorted CDRs, sorted and unsorted additional database information, and processed and unprocessed mailing lists. In addition, content may include advertising content in the form of multimedia, including text, images, graphics, and video. These are just a few of the types of content that may be transmitted through the I/O unit 304 and are exemplary in nature. As such, the examples should not be considered limiting the scope of the invention.

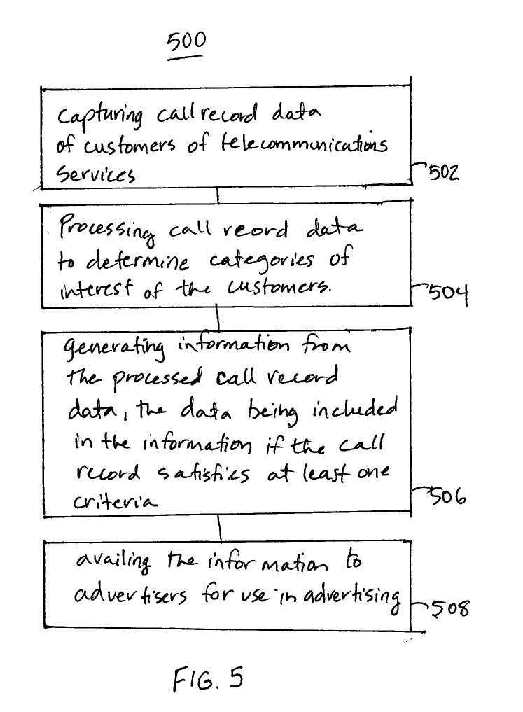

The server 302 may also include a processor 306 for processing the content. The processor 306 may execute software 308 capable of providing selection of targeted advertisements, processing the commands (such as those described previously), and distributing the targeted advertisements, among other functions. These functions are described below in greater detail in reference to FIG. 4, which detail exemplary software modules.

A storage unit 310 may also be included in the server 302. The storage unit 310 may be a hard drive or any other type of volatile or non-volatile memory capable of storing data. Within the data repository 310 may be one or more databases 312a-312n capable of storing and organizing data, such as content. In one embodiment, rather than including a storage unit 310, the server 302 may use memory 314 that is large enough to store sufficient content for a service provider's typical use. The memory 314 may also be located within the network server 302 for storing data being processed by the processor 306.

FIG. 4 is a block diagram of exemplary modules 400 of software 308 (FIG. 3) for collecting CDR data to provide targeted advertisements. By using data from existing databases, whether publicly accessible or not, and combining the data with CDRs collected at the service provider level, advertisements are able to be targeted more accurately and effectively. To effectively advertise, the following modules may be utilized. A categorization module 402 may be configured to determine categories in which a telephone number would be placed. For example, if the telephone number that is being called is a pizza restaurant, the categorization module 402 may place the telephone number in a restaurant category, pizza category, or both. The categorization module 402 may query and/or receive data from any number of sources, such as a telephone directory locally available or via the Internet, the data storage unit 204, or any number of additional data storage units 210 as described previously with respect to FIG. 2.

Having telephone numbers pre-categorized may assist in determining customers' interests by comparing known or derived categories to the number of calls made or received by a customer, particular neighborhood, ZIP code, or any other demographics (e.g., age, gender, financial status, political party affiliation) that can be made. If a person or demographic makes or receives a predetermined number of calls to a particular category, an association module 404 may associate the telephone number with a particular category. The association module 404 may store information indicative of customers' interests in any of the memory or storage repositories previously described for use in creating marketing lists or otherwise to enable advertisers to advertise to people with a particular interest. A customer look-up module 406 may interact with the association module to determine which customers, demographics, or both are associated with telephone numbers. The customer look-up module 406 may use publicly available databases, such as online phone books, census records, proprietary databases, or any other type of accessible data collection.

A notification module 408 may be used for assisting in delivering or communicating advertisements. The notification module 408 may directly provide for targeting the advertisements to customers, such as in a telephone bill or on a website where an electronic copy of the bill is displayed. Based on the telephone numbers dialed by the particular customer, the advertisements may be targeted using the modules as described previously. Another function of the notification module 408 may be to generate profiles of users based upon the calls made or received, and provide the profiles or portions thereof, to advertisers to data records, such as a mailing list. Notification of target advertising groups may also be given based on areas of various sizes, such as a neighborhood, ZIP code, city, or the like. Based on calling patterns or records, useful data may be generated. An exemplary record for providing data to an advertiser for use in targeting advertisements may be found in Table 2.

TABLE 2

| Name | Telephone # | Address | Gender | Age | Children | Income |
|---|---|---|---|---|---|---|
| Mary Mo | 214-897-2549 | 123 Joy St. Dallas, | F | 36 | 1 | 58,000 |
| | | TX 75230 | | | | |
| Bob Ellis | 214-555-8965 | 17 Ohio St. | M | 25 | 0 | 42,000 |
| | | Plano, TX 75275 | | | | |

There are several types of categorization that are useful for targeting advertisements that may be performed using the principles of the present invention. Three of them are described herein, but these are exemplary in nature and are not intended to limit the scope of the present invention.

One categorization is for when a particular business wants to obtain a mailing list of customers that have called with certain demographics (e.g., age, gender, residence, etc.) If the business is a customer of the service provider, the CDRs may be used to obtain calling party numbers with the external databases being referenced to determine the identity of callers that are not customers of the service provider. With this information, the business may be able to target known customers and efficiently spend advertising resources.

A second categorization may take CDRs of a service provider and provide information based on a type of business called. By using the CDRs of their customers and determining which types of businesses are called, service providers can generate useful information on customers that are likely to be more desired by particular types of businesses. For example, if a customer is known to have called a pizza restaurant a certain number of times, the customer may be considered in a category of people that like pizza. A list of people that like pizza may be aggregated and then sorted by various demographics, such as zip code or neighborhood. Categorizing callers to particular types of businesses is useful for providing information to industry participants (e.g., pizza restaurants) optionally in a particular geographic area. Whether a particular customer has been a customer of their particular establishment or not, the list can be useful because the list may include new customers with a demonstrated interest in a certain product (e.g., pizza). Adding to the utility, if the list of names is sorted by relevant demographics, such as location in the case of a pizza delivery restaurant, income in the case of a brokerage looking to target investors having over a set income, or political party affiliation in the case of a candidate wanting to target their particular party, the list may become even more useful. The information may be sold in the form of mailing lists that may be purchased from the service provider by any number of businesses, or may be sold as a demographic list that lists information based on particular zip codes, age range, etc.

A third type of categorization may be useful for a business that would like to get an idea of the demographics of the people that with which the business has been in contact, which may include both incoming and outgoing calls. For example, CDRs of a brokerage may be analyzed and information generated containing the income of potential investors that were in contact with the brokerage. Calls that were made to potential investors can be analyzed to determine if the right demographics are being reached. There are many other possible categorizations that are possible with these being listed to give as examples of some of the wide variety.

FIG. 5 is a flow diagram of an exemplary process 500 of providing targeted advertisements. Call record data of customers of telecommunications services may be captured at step 502. These are generally obtained in the form of CDRs and are stored by a service provider for billing purposes and various other record keeping purposes. Call record data may be processed to determine categories of interest of the customers in step 504. As described earlier, the CDRs may be analyzed in combination with other data sources to generate categories of interest that can be determined based on call records. In step 506, information may be generated from the processed call record data with the data being included in the information if the call record satisfies at least one criteria. Some examples of criteria that may be satisfied include a particular demographic (e.g. income over $50,000, gender, zip code) or having a demonstrated interest in a category (e.g., orders pizza or voted in a primary for a particular party). The information may be availed to advertisers for use in advertising in step 508. The information may take the form of a customer list or a demographics list. Still yet, advertisements may be inserted into bills that are generated by the service provider, or any other method for communicating advertisements using the information to people who may have an interest in a particular product or service.

The previous detailed description is of a small number of embodiments for implementing the invention and is not intended to be limiting in scope. One of skill in this art will immediately envisage the methods and variations used to implement this invention in other areas than those described in detail. The following claims set forth a number of the embodiments of the invention disclosed with greater particularity.

What is claimed as new and desired to be protected by Letters Patent of the United States is:

1. A method for providing targeted advertisements, said method comprising:
capturing call record data of customers of telecommunications services;
processing the call record data to determine categories of interest of the customers;
generating information from the processed call record data, customer data associated with the customers being included in the information if the call record data satisfies at least one criteria; and
availing the information to advertisers for use in advertising.

2. The method according to claim 1, further comprising creating a customer profile for each of the customers based on the processed call record data.

3. The method according to claim 1, further comprising creating customer profiles includes creating information for a business establishment including demographics of callers to the business establishment.

4. The method according to claim 1, wherein generating information includes generating information about customers within a geographical region.

5. The method according to claim 1, wherein processing the call record data to determine categories of interest includes determining restaurant type categories.

6. The method according to claim 1, wherein generating information includes generating information about individual customers.

7. The method according to claim 1, wherein processing the call record data includes processing calls placed and received.

8. The method according to claim 1, wherein generating information from the processed call record data includes generating information if the call record data satisfies greater than one call to a restaurant type.

9. The method according to claim 1, wherein generating information from the processed call record data includes generating a customer list.

10. The method according to claim 1, further comprising providing a targeted ad to a customer based on the captured call record data of the customer.

11. A system for providing targeted advertisements, said system comprising:
a processor configured to:
capture call record data of customers of telecommunications services;
process the call record data to determine categories of interest of the customers;
generate information from the processed call record data, data associated with the customers being included in the information if the call record data satisfies at least one criteria; and
avail the information to advertisers for use in advertising.

12. The system of claim 11, wherein said processor is further configured to create a customer profile for each of the customers based on the processed call record data.

13. The system of claim 11, wherein said processor is further configured to create customer profiles including information for a business establishment, the customer profile information including demographics of callers to the business establishment.

14. The system of claim 11, wherein said processor, in generating information, is further configured to generate information about customers within a geographical region.

15. The system of claim 11, wherein said processor, in processing the call record data to determine categories of interest, is further configured to determine restaurant type categories.

16. The system of claim 11, wherein said processor, in generating information, is further configured to generate information about individual customers.

17. The system of claim 11, wherein said processor, in processing the call record data includes processing calls placed and received.

18. The system of claim 11, wherein said processor, in generating information from the processed call record data, is further configured to generate information if the call record data satisfies greater than one call to a restaurant type.

19. The system of claim 11, wherein said processor, in generating information from the processed call record data, is further configured to generate a customer list.

20. The system of claim 11, wherein said processor is further configured to provide a targeted ad to a customer based on the captured call record data of the customer.
